(19) United States
(12) Patent Application Publication
(10) Pub. No.: US 2025/0196437 A1
(43) Pub. Date: Jun. 19, 2025

(54) Extreme performance scalable high strength hotend for fused filament fabrication systems

(71) Applicant: Colin Bonathan LLC, Dearborn, MI (US)

(72) Inventor: Colin R. Bonathan, Dearborn, MI (US)

(21) Appl. No.: 18/544,837

(22) Filed: Dec. 19, 2023

(51) Int. Cl. B29C 64/209; B29C 64/118; B33Y 10/00; B33Y 30/00

(52) U.S. Cl. CPC B29C 64/209; B29C 64/118; B33Y 10/00; B33Y 30/00

(57) ABSTRACT

A 3D printer hotend design wherein the extreme performance hotend addresses critical aspects of hotend performance, including thermal efficiency, structural rigidity, and compatibility with a wide range of filament materials. By utilizing a unique mechanically connected titanium tube structure, the disclosed hotend ensures optimal thermal transfer, dimensional stability, and increased filament flow, resulting in high-quality 3D prints.

### BACKGROUND OF THE INVENTION

A 3D printer hotend performs a critical role in the performance of a 3D printer. It needs to have a sharp thermal transition, a smooth internal structure for filament flow, and a rigid and stiff construction to prevent visual artifacts and damage to fragile components. Additionally, it should have efficient thermal transfer to fully melt the material and minimize energy loss to the surrounding environment. Furthermore, the hotend should be dimensionally stable at various temperatures and capable of withstanding high temperatures to print engineering polymers, including abrasive-embedded materials.

Traditional hotends consist of four components: the cold side, which is usually some form of heatsink, the heatbreak, the hot side, and the nozzle. Often, the heatbreak is the weakest link in the system. The function of the heatbreak is to stop the heat from transferring from the hot side to the cold side. To accomplish this, the heatbreak is typically thin, reducing the available cross section to transfer heat. However, this reduced cross section is not as mechanically strong as the rest of the hotend. Thickening the heatbreak for mechanical strength sacrifices thermal performance and can lead to clogging increased cooling requirements, or the inability to reliably process certain materials. Existing support systems for mechanically weak heatbreaks do not provide full-length support, and their thermal transfer may result in undesirable energy dissipation and waste heat.

The invention is an innovative solution that addresses the limitations of traditional hotend designs. It utilizes a mechanically connected titanium, stainless, or other robust and low-thermal conductivity material tube structure to achieve optimal thermal performance, structural rigidity, and compatibility with various materials. The tube structure features strategically placed holes that maximize thermal resistance while providing mechanical support throughout the length of the hotend. This design allows for a sharp thermal transition in the heatbreak while maintaining stiffness and torsional rigidity, across a wide range of processing temperatures.

The hotside and coldside are secured to the structural tube with perpendicular holes along its main axis, ensuring a secure and robust connection. The alternating hole pattern maintains structural rigidity while minimizing heat transfer to the cold side and its surrounding area. This design enables the invention to accommodate large temperature changes without significantly altering its overall length, simplifying use and calibration.

### SUMMARY OF THE INVENTION

The present subject matter pertains to the field of 3D printing technology, specifically improvements in the design and functionality of 3D printer hotends. The invention addresses the limitations and challenges of conventional hotend designs by incorporating a mechanically connected titanium, stainless, or other robust and low-thermal conductivity material tube structure that enables enhanced thermal performance, mechanical stability, and scalability. The invention features a sharp thermal transition, smooth filament flow, high rigidity, efficient thermal transfer, dimensional stability, and compatibility with high-temperature and abrasive materials. It offers a comprehensive solution that surpasses current performance standards within the 3D printing industry.

### BRIEF DESCRIPTION OF DRAWINGS

FIG. 1 shows a bottom view of an “air-cooled” variant of the hotend.

FIG. 2 shows an inverted front side view of an “air-cooled” variant of the hotend.

FIG. 3 shows an inverted right-side view of an “air-cooled” variant of the hotend.

FIG. 4 shows an inverted right-side rear view of an “air-cooled” variant of the hotend.

FIG. 5 shows an inverted left-side view of an “air-cooled” variant of the hotend.

FIG. 6 shows an inverted perspective view of an “air-cooled” variant of the hotend.

FIG. 7 shows a top view of an “air-cooled” variant of the hotend.

FIG. 8 shows a top view of a variant which uses a bimetallic heatbreak.

FIG. 9 shows a perspective view of a variant which uses a bimetallic heatbreak.

FIG. 10 shows a side view of a variant which uses a bimetallic heatbreak.

FIG. 11 shows a front view of a variant which uses a bimetallic heatbreak.

FIG. 12 shows a side view of a variant which uses a bimetallic heatbreak.

FIG. 13 shows a cutaway view of a variant which uses a bimetallic heatbreak.

FIG. 14 shows a bottom view of a variant which uses a bimetallic heatbreak.

FIG. 15 shows a cutaway view of a variant of the hotend using a square tube.

FIG. 16 shows a side view of a variant of the hotend using a square tube.

FIG. 17 shows a front view of a variant of the hotend using a square tube.

FIG. 18 shows a perspective view of a variant of the hotend using a square tube.

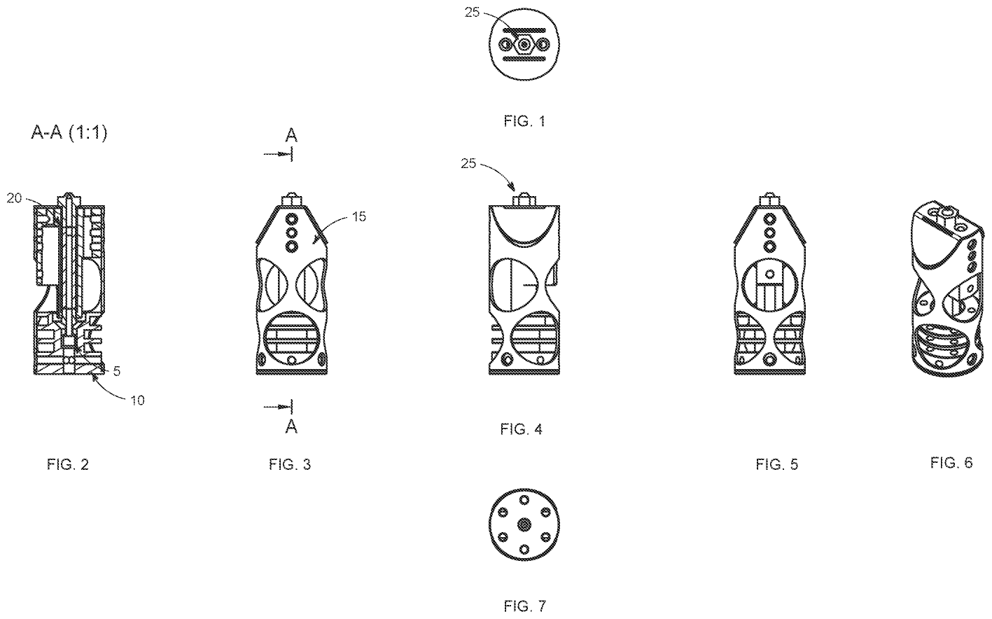

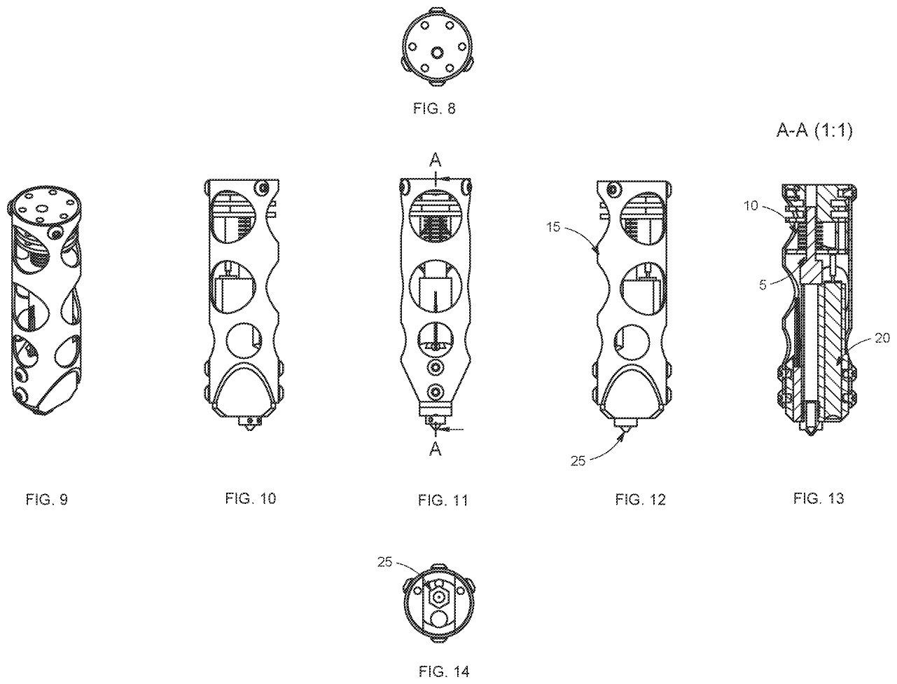

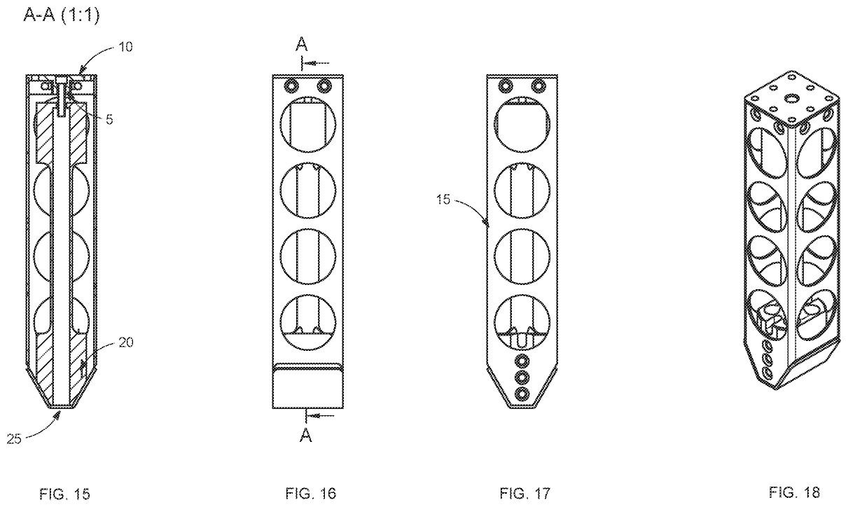

### DETAILED DESCRIPTION OF THE INVENTION

The invention consists of five main components: the heatbreak 5, the heatsink/cold side 10, the high-strength low thermal conductivity tube structure 15, the hot side 20, and the nozzle 25. The heatsink/cold side is where the solid polymer filament enters, and it dissipates the heat generated by the hot side, transferred to it through the heatbreak and by the high-strength low thermal conductivity tube structure. The heatbreak, located within the high-strength low thermal conductivity tube structure, creates the sharp thermal transition necessary for efficient printing. The hot side, heated by resistive or inductive means, transfers energy to the filament as it travels through to the nozzle for extrusion.

The tube structure is a key feature of the invention as it mechanically connects the cold side and the hot side, providing rigidity, strength, and support throughout the length of the hotend. The tube structure is made from a low thermal conductivity and high-temperature-sustaining material, such as titanium, stainless steel or other suitable material, ensuring dimensional stability and compatibility with various filament materials.

The tube structure incorporates strategically placed holes to achieve optimal thermal resistance while maintaining structural rigidity. The hole pattern can alternate to maintain stiffness while minimizing heat transfer to the surroundings and the cold side. This design feature allows the invention to prevent damage to the heatbreak while minimizing energy loss to the environment.

Furthermore, the invention's tube structure enables precise filament outlet positioning and stability, reducing nozzle deflection in motion, resulting in improved print quality. The enhanced thermal performance of the invention ensures uniform heat distribution along the filament path, preventing uneven melting and clogging issues.

The hot side of the invention consists of one or several block(s) located within the rigid tube structure, which utilizes a cavity to guide the filament along its path. This cavity is heated utilizing a heating element, such as a resistive heater, induction heater, or other. The hot side ensures the filament is fully melted, constrained, and ready for extrusion.

The nozzle, located at the outlet of the hot side of the invention, determines the diameter of the extrudate and plays a vital role in printing resolution and quality. The nozzle is detachable and interchangeable with other industry available nozzles, allowing the user to make adjustments to fit their desired printing roles.

The invention's unique design offers improved thermal efficiency, structural rigidity, and compatibility with a wide range of filament materials. Its mechanically connected tube structure provides optimal thermal transfer, dimensional stability, and increased filament flow, resulting in high-quality 3D prints.

The invention also offers benefits in terms of maintenance and user experience. The detachable nozzle allows for easy cleaning and maintenance, reducing downtime and increasing productivity. The compatibility with various filament materials expands the possibilities for 3D printing applications. The invention's design also ensures reliability through durability, making it suitable for both hobbyists and professionals in the 3D printing industry.

In conclusion, the invention represents a valuable advancement in 3D printer hotend technology as its mechanically connected tube structure, along with the strategic hole pattern, ensures optimal thermal transfer, structural rigidity, and compatibility with various filament materials. The invention offers improved print quality, user experience, and versatility, making it an invaluable tool for 3D printing enthusiasts and professionals alike.

1. An extreme performance hotend comprising:
a) a cold side including a heatsink through which a solid polymer filament enters and heat conducted from the hotside through the heatbreak is dissipated,
b) a hot side including at least one heatblock with a cavity for transferring heat energy to the filament, and
c) a tube structure mechanically connecting the cold side and hot side, said tube structure having holes strategically placed to provide thermal resistance and structural support throughout the length of the hotend.

2. The extreme performance hotend of claim 1, wherein the tube structure is non-thermally conductive, rigid, and capable of sustaining high temperatures.

3. The extreme performance hotend of claim 1 or 2, wherein the holes in the tube structure can alternate in location and pattern to maintain structural rigidity while minimizing thermal transfer to the surroundings and the cold side.

4. The extreme performance hotend of any preceding claim, wherein the length of the hot side can be increased to accommodate higher extrusion rates while maintaining strength and support provided by the tube structure.

5. The extreme performance hotend of any preceding claim, wherein the hotend is dimensionally stable at various temperatures, enabling precise and consistent prints.

6. A 3D printer incorporating the extreme performance hotend as claimed in any of claims 1-5.

7. A method of 3D printing using the extreme performance hotend as claimed in any of claims 1-6, comprising the steps of:
a) feeding a solid polymer filament into the cold side of the extreme performance hotend,
b) transferring heat energy from the hot side to melt the polymer filament,
c) extruding the molten polymer through a nozzle for deposition, and
d) cooling the extruded material to solidify it, and e. continuing the process to create a desired three-dimensional object.

8. The method of claim 9, wherein the extreme performance hotend allows for consistent and precise printing due to its structural rigidity and minimal thermal transfer.

9. The method of claim 7 or 8, wherein the extreme performance hotend supports the printing of various polymers, including engineering polymers and abrasive-embedded polymers.

10. The method of any of claims 7-9, wherein the extreme performance hotend accommodates different filament extrusion rates by adjusting the length of the hot side while maintaining stability and performance.

11. A 3D printed object produced using the extreme performance hotend as claimed in any of claims 1-7, exhibiting high-quality print characteristics, dimensional accuracy, and strength.
